(19) United States
(12) Patent Application Publication
(10) Pub. No.: US 2010/0059982 A1
(43) Pub. Date: Mar. 11, 2010

(54) Mud Wing Having Directional Spray Suppression

(76) Inventor: Andreas Franz Schubert, Wiesbaden (DE)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/209,194

(22) Filed: Sep. 11, 2008

(51) Int. Cl. B62D 25/18

(52) U.S. Cl. 280/851

(57) ABSTRACT

Mud wings of the present invention include an enclosed space in which water diverters are disposed in positions and in orientations that cause water entering the enclosed space through the front panel of the mud wing to directionally drain to a predetermined exit port in the mud wing. In one embodiment, the exit port is located on the bottom portion of a thin sidewall of the mud wing that is designed to release water on the inboard side of the tire path, which prevents the water from being deposited into the path of any rearward tires.

### FIELD OF THE INVENTION

The present invention is in the field of vehicular mud wings, and, more specifically, the present invention is in the field of mud wings to which a spray suppression technology has been applied.

### BACKGROUND

Mud wings are found on virtually every truck and many other types of vehicles that are in common use today as a mechanism that is used to prevent tires from spraying debris and water in an uncontrolled manner. Mud wings are typically fairly rigid and are formed around a tire or set of tires in a manner that blocks debris and liquids thrown up from the tires to the front, above, and to the back. Typically, a flexible mud flap is attached to and hangs down from the mud wing on the back portion of the mud wing, which allows the suppression of a greater amount of rearward tire spray without having to extend the mud wing too far toward the road surface.

Simple mud wings can be formed from, for example, a single sheet of thick rubber or other flexible material, or can be rigid structures, such as rubber framed with light gauge metal, or simply a formed piece of rigid metal, such as steel.

Simple mud wings, while effective at blocking a substantial portion of tire discharge, are not effective at preventing water from being redirected off of the mud wing and out into traffic lanes or under the vehicle on which the simple mud flaps are installed. Spray that is collected within the mud wing typically can flow to the sides of the wing, pushed by air velocity generated by the movement of the vehicle, and fall back out into the air stream where a portion of the collected water re-disperses off of the sides of the mud wing, thereby reforming hazardous spray.

In response to that deficiency, mud wings incorporating spray suppression technology have been extensively developed. Examples include European patent publications EP150588, EP149665, EP112694, and EP0556733.

Existing spray suppression technology, of which the inventors are aware, however, are ineffective at preventing water from being redirected onto the roadway and into the path of any trailing tires on the same vehicle. That ineffectiveness can impact both the handling performance of the vehicle, which can be compromised by excessive water accumulation under the tires, and the extent of spraying of the tires, which can be substantially worsened by the channeling of water from each tire to the trailing tires. Further, all of the water that is collected by the spray suppression material in a mud wing drains vertically down the face of the spray suppression material and can be re-dispersed when hit by new spray thrown from the vehicle tires.

Accordingly, what are needed in the art are improved mud wing designs that improve spray suppression and water distribution.

### SUMMARY OF THE INVENTION

Mud wings of the present invention include an enclosed space in which water diverters are disposed in positions and in orientations that cause water entering the enclosed space through the front panel of the mud wing to directionally drain to a predetermined exit port in the mud wing. In one embodiment, the exit port is located on the bottom portion of a thin sidewall of the mud wing that is designed to release water on the inboard side of the tire path, which prevents the water from being deposited into the path of any rearward tires.

### BRIEF DESCRIPTION OF THE DRAWINGS

FIG. 1 represents a schematic, perspective, cutaway view of one embodiment of a mud wing of the present invention.

FIG. 2 represents a schematic, perspective, cutaway view of one embodiment of a mud wing of the present invention.

FIG. 3 represents a schematic, perspective view of one embodiment of a front panel of the present invention incorporating energy absorbing projections.

FIG. 4 represents a schematic, cross sectional view of one embodiment of a front panel of the present invention.

### DETAILED DESCRIPTION

The present invention provides mud wings that have an enclosed space in which one or more water diverters have been included to shunt water toward a specified port in the mud wing, thereby reducing or eliminating the problem in the art of water being shed from mud wings into the path of rearward tires.

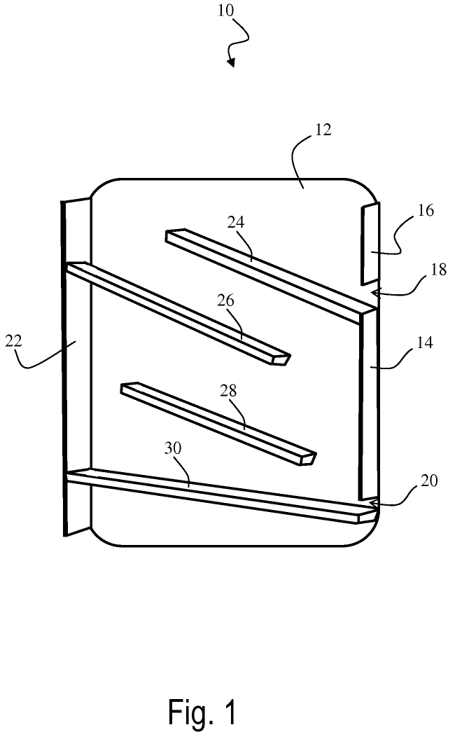

As shown in FIG. 1 generally at 10 in a cutaway view in which the front panel is not shown, a mud wing of the present invention includes a back panel 12. The back panel 12 can be any suitable material, and, in some embodiments the panel can be a conventional mud wing. The back panel 12 will usually be solid and impermeable to water, but can define openings if desired for the particular application. For example, overflow openings can be formed in the back panel 12 to allow for water escape in the event that a port becomes obstructed.

A first side wall 22 is disposed in contact with the back panel 12. In this embodiment, it is shown as a solid and continuous wall, but, in other embodiments, the first side wall can define one or more ports.

A second side wall, in this embodiment, has an upper section 16 and a lower section 14 that together form the second side wall 14, 16. The second side wall 14, 16 defines a first port 18 and a second port 20. In various embodiments, the second side can comprise substantially all ports, with very little edge material. In various embodiments for example, one or both side walls can comprise up to 80% or 95% port space. In other embodiments, port space on one or both side walls is limited to less than 50%, 30%, 15%, or 10% port space. In FIG. 1, for example, the first side wall 22 is shown with 0% port space and the second side wall 14, 16 is shown with about 20% port space.

A front panel, which is not shown, is placed in position in contact with the first side wall 11 and the second side wall 14, 16 to complete the exterior of the mud wing, thereby defining an enclosed space inside the mud wing. The front panel defines openings that allow water to pass from the front of the mud wing, through the front panel, and into the space. The front panel is positioned facing a tire in the final application. Openings in the front panel can be holes, slots, or any other suitable opening that allows water that is sprayed onto the front panel from the tire to be diverted through the openings and into the space in the mud wing.

One or more water diverters are positioned in the defined space in locations and at angles that cause water entering the space to be directed to one or more ports defined in the second side wall 14, 16. As shown in FIG. 1, four water diverters 24, 26, 28, 30 are disposed within the space and in contact with the front panel and the back panel 12. Because the water diverters are positioned at an angle to horizontal in the embodiment shown, water entering the space will be pulled downward by gravity, will strike a water diverter, and will be moved toward either the first port 18 or the second port 20. Of course, those of skill in the art will recognize that one or more water diverters can be positioned horizontally, which, while potentially less efficient than angled water diverters, can still effectively direct water toward one or more ports. Further, water diverters can be formed in any suitable shape, and can be, for example, straight, curved, angular, or any combination thereof, as desired for the particular application.

The arrangement and number of water diverters and ports is not critical to the present invention, and, depending on the size of the mud wing and the intended use, as few as one water diverter and as many as dozens may be used to achieve the desired result. In various embodiments, 1-20, 1-15, or 1-10 water diverters are used. In various embodiments, 1-10, 1-8, or 1-5 ports are used. In various embodiments, a single port is used.

Further, while the water diverters 24, 26, 28, and 30 in FIG. 1 are shown formed directly on the back panel 12, in other embodiments the water diverters can be formed directly on the front panel or can be attached to either or both of the side walls. In yet further embodiments, the water diverters can be trapped between the front and back panels and held in place by pressure, or the water diverters can be disposed in grooves formed in the inner surface of either or both of the back panel and the front panel.

Additionally, water diverters of the present invention can be disposed in the enclosed space in any manner that functions to quickly and effectively direct water to ports, and are therefore not limited in either angle or direction, and, while it is generally preferable that the water diverters are in contact with both the front and the back panels, thereby preventing downward flow around the water diverters, in some embodiments one or more water diverters are in discontinuous contact with either the front panel, the back panel, or both.

In one particular embodiment that is suitable for retrofit applications, water diverters and side walls are formed directly on the front panel. The three sided structure can then be easily attached to an existing, conventional mud wing, which then serves as the back panel. Such an application can be easy constructed by injection molding a suitable thermoplastic polymer into a single piece that incorporates the water diverters, side walls (with defined ports), and front panels. That single piece can then be retrofitted in the field to existing mud wings using any suitable attachment means to form a mud wing of the present invention.

As shown in FIG. 1, the ports 18, 20 defined by the second side wall 14, 16 allow water to drain to the side of the path of rearward tires simply by restricting the discharge of water to locations on the side of the mud wing. Even further directional control over water dispersion can be gained, however, by adding a hose or other suitable structure directly to the ports. In one embodiment, for example, only a single port is formed in the mud wing, and the port is formed into, or is fitted with, a barb fitting or cylindrical projection to which a hose can be attached. In such an embodiment, water discharging from the mud wing can be directed to any portion of the undercarriage of the vehicle, including, for example, to a position rearward of the rear most tires.

Instead of tubes, other embodiments employ a direct extension of the side wall and front and back panels around the ports. For example, the side wall and front and back panels around a port can be formed into a channel that extends well beyond the main side wall of the mud wing toward the centerline of the vehicle, which directs water, for example, well inboard of the inner tire surface.

Water diverters of the present invention can be angled at any desired angle. In various embodiments, the angle of water diverters off of the horizontal increases from top to bottom of the mud wing. Angle, length, height placement, and so on are best determined with reference to the intended application, of course. In various embodiments, as discussed above, one or more water diverters are positioned horizontally.

While the embodiment show in FIG. 1 advantageously directs water to ports 18, 20 located on a single side of the mud wing, it will be clear to artisans that mud wings of the present invention can be reversed, and a single vehicle will typically have mud wings that are mirror images of each other on opposing sides of the vehicle. Alternatively, for a large truck with two adjacent tires on each side of an axle, it is possible to employ mirror image, adjacent mud wings that will shunt water to the inside of the inner tire and to the outside of the outer tire.

In further embodiments, ports can included in both side walls of the mud wing, and water diverters can be designed to direct water in both directions. Such an embodiment would be useful, for example, in applications having relatively wide and short mud wings, where efficient transfer of water across the full width of a mud wing would be difficult to achieve.

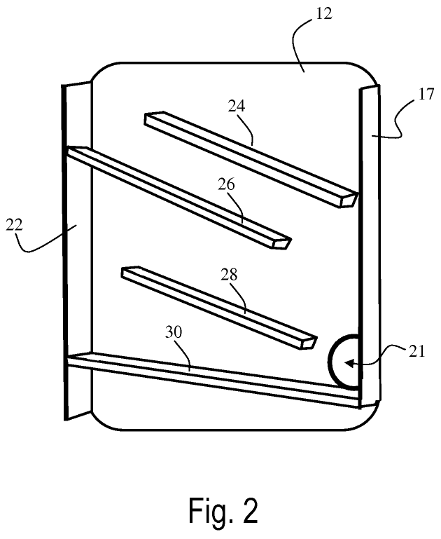

In other embodiments, ports can be formed in a portion of the back panel, which is particularly useful when hoses or other conduits are used to direct water away from the mud wing. One embodiment of such a mud wing of the present invention is shown in FIG. 2, which shows a solid second side wall 17 and a port 21 formed in the lower portion of the rear panel 12. In this embodiment, for example, the port 21 can feed directly into a fitting that allows for the direct attachment of a hose or other water routing means. Alternatively, the port 21 can lead to a fitting or passageway that redirects the water toward one or both of the sidewalls of the mud wing, thereby directing the water in a manner that is similar to the embodiment shown in FIG. 1.

In a further embodiment ports are formed in both side walls and in the center, bottom of the back panel, and all three ports are connected with hosing. In this embodiment, water entering the space is directed quickly to the nearest port, where it is discharged and carried away with tubing. This type of an application would be useful in applications in which a relatively wide mud wing is employed in conditions where substantial water ingress into the mud wing is expected. Without multiple porting, water movement could be restricted. A variation of this embodiment involves adding an enclosed channel to the back side of the back panel into which rear ports or one or both side ports can discharge water. In these embodiments, water that is discharged from the space through the ports enters the enclosed channel, which may be, for example, a simple tube-shape that is angled and open on the low end, and is directed through the channel to the terminus of the channel, which can be, for example, well inboard of the inner tire surface.

For any of the embodiments given herein throughout, 100%, or greater than 80% or 90%, of the water entering the enclosed space is directed through one or more ports of the present invention. Further, mud wings of the present invention capture at least 30%, 40%, or 50% of the water incident upon the front panel and direct that water to the enclosed space and one or more ports and thus away from the path of trailing tires.

The front panel of the mud wing can be any suitable material, whether rigid or flexible, that defines an opening through which water can flow to reach the space defined by the mud wing. Examples include rigid materials and flexible materials having openings formed therein, including, for example, rigid and flexible rubber and plastic, light gauge metal, and the like. While it is generally preferred to have smaller openings defined throughout the front panel in a dispersed and regular pattern, any suitable combination of opening size and distribution can be used to suit the intended purpose. Any suitable and effective energy absorbing, spray suppression system can be integrated with a front panel or used directly as a front panel in a mud wing of the present invention.

In one particular embodiment, a spray suppression technology is applied to the outside surface of the front panel. One useful spray suppression technology utilizes energy absorbing projections on the front panel, which temporarily trap water thrown against the front panel by the tires. One such spray suppression technology is composed of polymeric, finger like elements projecting off of the base surface and resembling grass (for example, ClearPass®, Solutia Incorporated), which acts to absorb the energy of sprayed water and direct the water through the openings in the front panel and into the space.

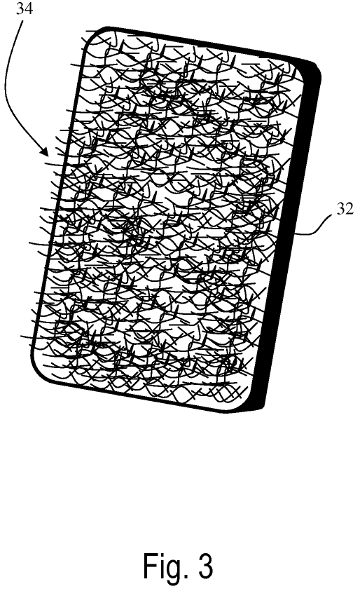

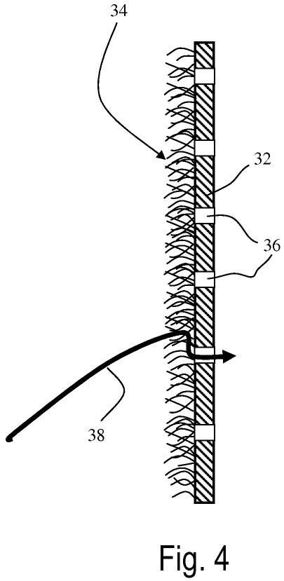

One such embodiment is shown in FIG. 3, which shows a front panel 32 having energy absorbing projections in the form or polymeric, finger like elements 34 that resemble artificial grass. Openings defined by the front panel 32 are not shown in this view. Water that is directed from a tire onto the front panel 32 is temporarily trapped by the energy absorbing projections 34. As water accumulates, it is forced through the openings (not shown) in the front panel, and into the enclosed space. This process is shown in FIG. 4, which is a schematic, cross sectional drawing of the front panel shown in FIG. 3. As shown, front panel 32 is covered with energy absorbing projections 34 on the surface that faces a tire. The front panel 32 defines openings 36 throughout. The path that water takes is shown as element 38, which shows water directed at the energy absorbing projections 34, where the water is trapped. The water then accumulates and is forced through an opening 36 and into the enclosed space behind the front panel 32. The openings 36 can be formed in any suitable shape.

In various embodiments, a front panel of the present invention is formed from a polyethylene base having a thickness of from 1 to 10 millimeters, and preferably 1 to 3 millimeters, on which energy absorbing projections in the form of polymeric, finger like elements have been formed. The projections can, for example, extend 10-30 millimeters off of the base of the front panel.

As suggested above, mud wings of the present invention can be held in an assembled form using any suitable fastener, which can include clips, an edge frame, bolts and nuts, screws, and the like. Fasteners are typically applied in a manner that does not restrict water flow to and over the water diverters. For example, in embodiments in which separate back and front panels are used and attached to an existing, conventional mud wing to form a modified mud wing, aligned holes in the front and back panels can be formed throughout the mud wing of the present invention at suitable points, as required for proper retention, such as directly under the water diverters in a position where water flow would be virtually unobstructed.

In a preferred embodiment, a mud wing of the present invention has a back panel that has multiple plastic stakes projecting toward the front panel, which has been formed to have holes corresponding to the stakes. Assembly is performed by combining the back panel and front panel so that the plastic stakes project through the front panel, after which the exposed tips of the stakes are melted down so that the stakes cannot be pulled back through the front panel, which is known as thermal staking. In one embodiment, the stakes each define a hollow cylinder inside, which allows, for example, on-vehicle repairs to be performed by using screws that will self-tap inside of each stake.

The present invention includes and provides a method of suppressing water spray from a vehicle tire comprising utilizing any of the mud wings described herein on a vehicle having the tire.

By virtue of the present invention, it is now possible to provide mud wings that have improved water spray suppression and the capacity to directionally channel water away from the path of rearward tires, thereby improving handling and safety.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

It will further be understood that any of the ranges, values, or characteristics given for any single component of the present invention can be used interchangeably with any ranges, values, or characteristics given for any of the other components of the invention, where compatible, to form an embodiment having defined values for each of the components, as given herein throughout. For example, mud wings having a various number of ports and comprising different thermoplastic polymers can be combined to form many permutations that are within the scope of the present invention, but that would be exceedingly cumbersome to list.

Any figure reference numbers given within the abstract or any claims are for illustrative purposes only and should not be construed to limit the claimed invention to any one particular embodiment shown in any figure.

Figures are not drawn to scale unless otherwise indicated.

Each reference, including journal articles, patents, applications, and books, referred to herein is hereby incorporated by reference in its entirety.

We claim:

1. A mud wing, comprising:
a back panel
a first side wall disposed in contact with said back panel and projecting outward therefrom;
a second side wall disposed in contact with said back panel and projecting outward therefrom, wherein said second side wall is disposed opposite said first side wall on said back panel;
a front panel disposed in contact with said first side wall and said second side wall, wherein said front panel defines openings through which water may pass, wherein said back panel, said first side wall, said front panel, and said second side wall define an enclosed space; and,
one or more water diverters disposed between and in contact with said back panel and said front panel, wherein one or more ports are defined in one or more of said first side wall, said second side wall, and said back panel;
wherein, when water enters said space through said openings in said front panel, said water will be pulled downward by gravity into said one or more water diverters, which will divert said water toward said one or more ports, after which said water will drain from said space through said one or more ports.

2. The mud wing of claim 1, wherein said one or more ports are defined only in said second side wall.

3. The mud wing of claim 1, wherein said one or more ports are defined only in said back panel.

4. The mud wing of claim 1, wherein said back panel defines a single port.

5. The mud wing of claim 1, wherein said second side panel defines 1-10 ports and neither of said back panel nor said first side panel define ports.

6. The mud wing of claim 1, comprising 1-20 water diverters.

7. The mud wing of claim 1, wherein said front panel includes a spray suppression system.

8. The mud wing of claim 7, wherein said spray suppression system is polymeric, finger like elements projecting off of the base surface.

9. The mud wing of claim 8, wherein said front panel has a thickness of 1 to 10 millimeters and comprises polyethylene.

10. The mud wing of claim 1, wherein said front panel transmits at least 30% of water incident on its surface into said enclosed space.

11. The mud wing of claim 1, wherein greater than 90% of water entering said space is discharged from said one or more ports.

12. The mud wing of claim 1, wherein said first side wall defines one or more ports, said second side wall defines one or more ports, and said back panel does not define any ports.

13. The mud wing of claim 1, wherein said one or more water diverters divert water toward said second side wall.

14. The mud wing of claim 1, wherein said one or more water diverters divert water in two directions.

15. The mud wing of claim 1, wherein said one or more ports are connected to a fitting that allows attachment of a tube to said one or more ports.

16. The mud wing of claim 1, wherein said water diverters are integrated into said back panel.

17. The mud wing of claim 1, wherein said water diverters are integrated into said front panel.

18. The mud wing of claim 1, wherein said back panel comprises hollow stakes projecting toward and passing through said front panel, wherein said hollow stakes are thermally staked and hold said front panel in position.

19. The mud wing of claim 1, wherein said hollow stakes can accept a self tapping screw.

20. A method of controlling water spray produced by a tire, comprising:
installing behind said tire a mud wing, comprising:
a back panel
a first side wall disposed in contact with said back panel and projecting outward therefrom;
a second side wall disposed in contact with said back panel and projecting outward therefrom, wherein said second side wall is disposed opposite said first side wall on said back panel;
a front panel disposed in contact with said first side wall and said second side wall, wherein said front panel defines openings through which water may pass, wherein said back panel, said first side wall, said front panel, and said second side wall define an enclosed space; and,
one or more water diverters disposed between and in contact with said back panel and said front panel, wherein one or more ports are defined in one or more of said first side wall, said second side wall, and said back panel;
wherein, when water enters said space through said openings in said front panel, said water will be pulled downward by gravity into said one or more water diverters, which will divert said water toward said one or more ports, after which said water will drain from said space through said one or more ports.
